(19) United States
(12) Patent Application Publication
(10) Pub. No.: US 2013/0003028 A1
(43) Pub. Date: Jan. 3, 2013

(54) FLOATING VIRTUAL REAL IMAGE DISPLAY APPARATUS

(75) Inventor: CHIH-HSIUNG LIN, New Taipei City (TW)

(73) Assignee: Era Optoelectronics Inc., New Taipei City (TW)

(21) Appl. No.: 13/244,460

(22) Filed: Sep. 24, 2011

(30) Foreign Application Priority Data
Jun. 28, 2011 (TW) 100122661

(51) Int. Cl. G03B 21/28

(52) U.S. Cl. 353/98

(57) ABSTRACT

A floating virtual real image display apparatus includes a scanning mechanism, a real image imaging unit and a light source; a light beam emitted from the light source is reflected and refracted by the real image imaging unit to generate a real image corresponding to the light source; a position of said real image is altered through a scanning of the scanning mechanism to generate a floating virtual image; the floating virtual image is allowed to display a variable virtual image by controlling the light source to emit bright, dark light beams corresponding to an image through the image signal processing unit.

### BACKGROUND OF THE INVENTION

1. Field of the Invention

The present invention relates to a display apparatus, and more particularly to a floating virtual display apparatus capable of being used as a screen.

2. Description of Related Art

Taiwan publishing patent NO. 200951771 discloses an apparatus with a virtue touch screen, including a screen, an optical mechanism, and a detection module, where the optical mechanism has at least one optical lens The picture on the screen is formed into a corresponding virtual screen image in a space through the optical mechanism by means of optical imaging principle. The detection module is used to detect whether a user touches the virtual screen image or not, detect and analyze the position of a contact position with the virtual screen, and transfer the position to a contact position with the screen corresponding thereto and signal commands so that the user can operate the digital contents displayed on the virtue screen with a touch control mode, thereby achieving the effect of operating the screen substantially instead of touching it directly. The above-mentioned Taiwan published patent still need use a general screen to provide the images needed for the virtual screen, and a traditional screen cannot be omitted to reduce the cost.

Referring to FIG. 1A, when a light beam emitted from a high-power light source 1 illuminates a real image imaging unit 21 such as a concave lens, it will be reflected and refracted to generate a floating real image 31 corresponding to the light source 1 in front of the concave lens, and a virtual image 11 corresponding to the light source 1 behind the concave lens.

Referring to FIG. 1B, another real image imaging unit 22 includes a convex lens 222 or a Fresnel lens having an imaging function and a mirror 221. When a light beam emitted from a high-power light source 1 illuminates the mirror 221, it will be reflected by the mirror 221 to the convex lens 222 or the Fresnel lens having an imaging function to generate a floating real image 31 corresponding to the light source 1, and a virtual image 11 corresponding to the light source 1 behind the mirror 221.

Referring to FIG. 2, a micro electro mechanical system (MEMS) scanning mechanism made by combining a MEMS 41 with a micro scanning mirror (MSM) 42 is now available in the market. When a light beam corresponding to a fixed or moving image is emitted from a light source 43 and then projected on the MSM 42, the MSM scans it from left to right and from top to down, and projects it to a projecting surface 40 such that a corresponding image can then be displayed. But, the MSM projector cannot project a floating moving image currently.

### SUMMARY OF THE INVENTION

To improve a conventional floating virtual display apparatus, the present invention is proposed.

The main object of the present invention is to provide a floating virtual real image display apparatus, including a scanning mechanism, and a real image imaging unit and a light source; when a light beam emitted from the light source, it will be reflected and refracted by the real image imaging unit to generate a real image corresponding to the light source; a floating virtual image is generated after the position of the real image is altered through the scanning of the scanning mechanism.

Another object of the present invention is to provide a floating virtual real image display apparatus, allowing a floating virtual image to display a variable virtual image like a floating moving screen by controlling a laser light source to emit bright, dark light beams corresponding to an image.

### BRIEF DESCRIPTION OF THE DRAWINGS

The present invention can be more fully understood by reference to the following description and accompanying drawings, in which:

FIG. 1A is a schematic view, showing that a conventional light source and real image unit are used to generate a floating real image;

FIG. 1A is a schematic view, showing that anther conventional light source and real image unit are used to generate a floating real image;

FIG. 2 is a schematic view of a conventional MSM projector, projecting an image;

FIG. 3A is a schematic view of a floating virtual real image display apparatus of a first preferred embodiment according to the present invention;

FIG. 3B is a schematic view of a floating virtual real image display apparatus of a second preferred embodiment according to the present invention;

FIG. 4 is a schematic view of a floating virtual real image display apparatus of a third preferred embodiment according to the present invention;

FIG. 5A is a schematic view of a floating virtual real image display apparatus of a fourth preferred embodiment according to the present invention; and

FIG. 5B is a schematic view of a floating virtual real image display apparatus of a fifth preferred embodiment according to the present invention.

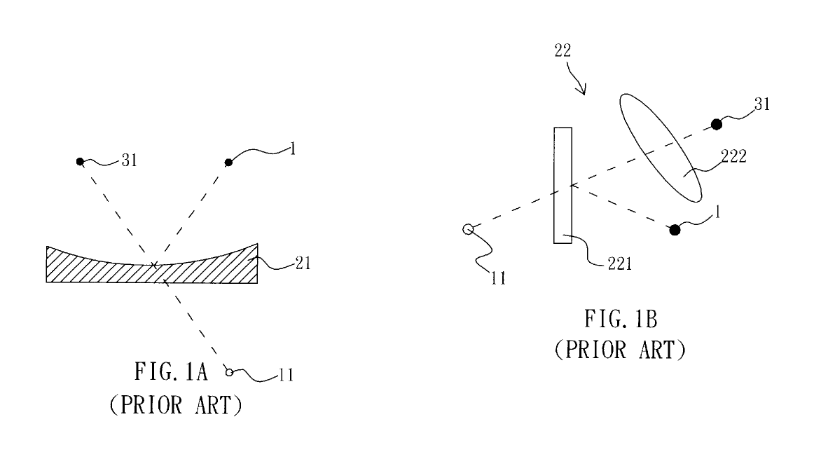

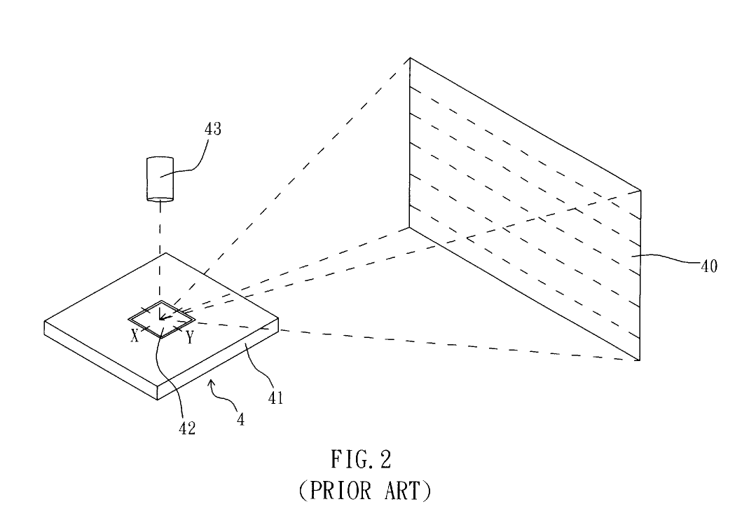

### DETAILED DESCRIPTION OF THE PREFERRED EMBODIMENTS

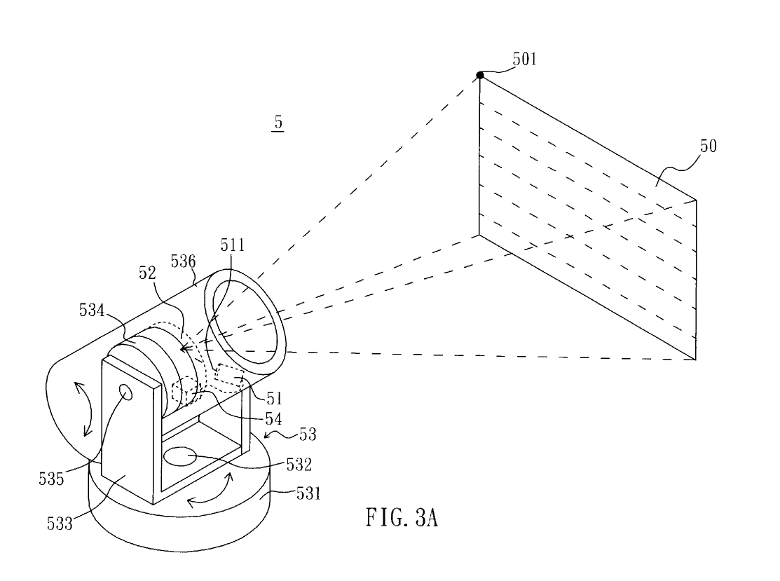

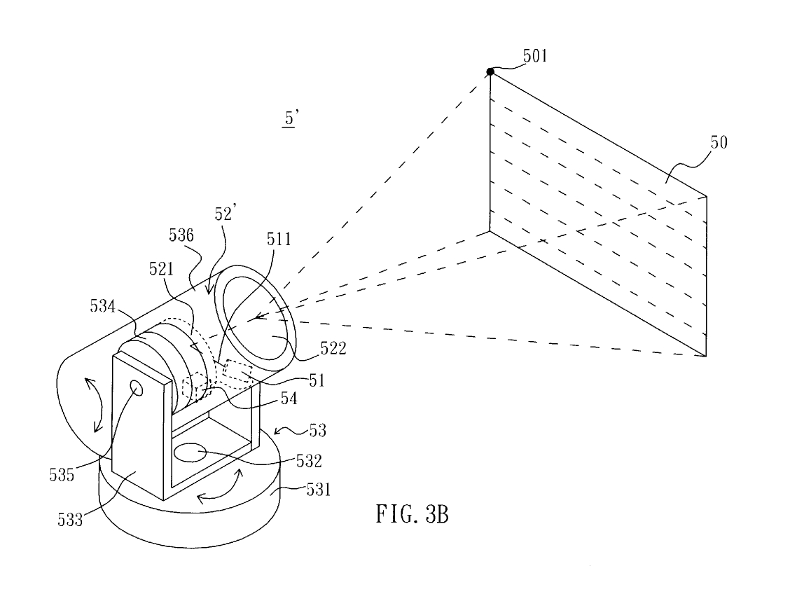

Referring to FIG. 3A, a floating virtual real image display apparatus 5 of a first preferred embodiment according to the present invention includes a high-power light source 51, an real image imaging unit 52, a scanning mechanism 53 and an image signal processing unit 54. The light source 51 is electrically connected to the image signal processing unit 54. The scanning mechanism 53 is a conventional structure and configured with a first motor 531, a first shaft (x-axis) 532, a first bracket 533, a second motor 534, a second shaft (Y-axis) 535 and a second bracket 536. The first bracket 533 is respectively coupled to the first shaft 532 and the second motor 534, and the second shaft 535 is coupled to the second bracket 536. The first motor 531 can drive the first shaft 532 to rotate, allowing the first bracket 533 to take the first shaft 532 as a rotating axis scanning from left to right repeatedly, and the second motor 534 can drive the second shaft 535 to rotate, allowing the second bracket 536 to take the second shaft 535 as a rotating axis scanning up-down repeatedly.

The light source 51, real image imaging unit 52 and image signal processing unit 54 are respectively coupled to the second bracket 536 of the scanning mechanism 53. The real image imaging unit 52 is a concave lens. The scanning way of the scanning mechanism 53 is first taking the first shaft. 532 as a rotating center scanning from left to right, and then taking the second shaft 535 as a rotating center rotating down-up a small angle. Thereafter, the scanning mechanism 53 takes the first shaft 532 as a rotating center again rotating from right to left, and repeats the above-mentioned procedures scanning from left to right and up to down over and over again.

When a light beam 511 is emitted from the light source 51, the light beam 511 is reflected and refracted by the real image imaging unit (concave lens) 52 to generate a real image 501. A floating virtual image 50 is displayed to a human's vision through human persistence of vision after the position of the real image 501 is altered through the scanning of the scanning mechanism 53 with a scanning speed of more than 24 times per second to the whole picture of the virtual image 50. The floating virtual image 50 is allowed to display a variable virtual image like a floating moving screen by controlling the light source 51 to emit different bright, dark light beams corresponding to an image through the image signal processing unit 54.

Referring to FIG. 3B, a floating virtual real image display apparatus 5′ of a second preferred embodiment according to the present invention includes a high-power light source 51, an real image imaging unit 52′, a scanning mechanism 53 and an image signal processing unit 54. The real image imaging unit 52′ of the present embodiment includes a convex lens 522 or a Fresnel lens having an imaging function and a mirror 521. The structures and functions of the present embodiment are approximately similar to the floating virtual real image imaging apparatus of the first embodiment except the present embodiment has the combination mirror 521 and the convex lens 522 or Fresnel lens having an imaging function stead of the concave lens in the first embodiment. The details are omitted here.

In the present embodiment, a light beam emitted from the light source 51 is reflected by the mirror 521 to the convex lens 522 or Fresnel lens having an imaging function, and then refracted by the convex lens 522 or Fresnel lens having an imaging function to generate an real image 501, and a floating virtual image 50 is generated after the position of the real image 501 is altered through the scanning of the scanning mechanism 53.

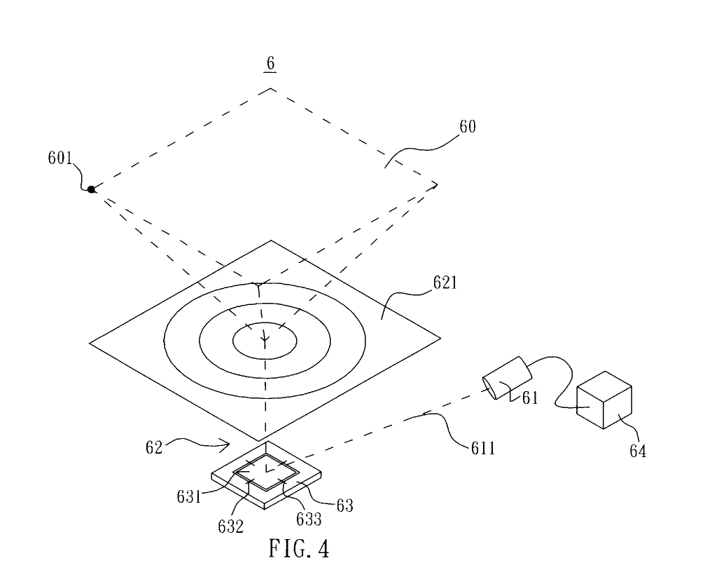

Referring to FIG. 4, a floating virtual real image display apparatus 6 of a third preferred embodiment according to the present invention includes a high-power light source 61, a real image imaging unit 62, a scanning mechanism 63 and an image signal processing unit 64. The light source 61 is electrically connected to the image signal processing unit 64. The scanning mechanism 63 is installed with a scanning mirror 631, and the scanning way of the scanning mirror 631 is first taking a first axis (X-axis) 632 as a rotating axis scanning from left to right repeatedly, and then taking a second axis (Y-axis) 633 as a rotating axis rotating down-up a small angle. Thereafter, the scanning mirror 631 repeats the above-mentioned procedures scanning from left to right and up to down over and over again. The real image imaging unit 62 includes a combination of a convex lens 621 or Fresnel lens having an imaging function and the mirror 631.

A light beam 611 is reflected and refracted by the real image imaging unit 62 to generate a real image 601 when the light beam 611 is emitted from the light source 61. A floating virtual image 60 is displayed to a human's vision through human persistence of vision after the position of the real image 601 is altered through the scanning of the scanning mechanism 63 with a scanning speed of more than 24 times per second to the whole picture of the virtual image 60.

In the present embodiment, the light beam 611 is emitted from the light source 61 is first reflected by the scanning mirror 631 to the convex 621 or Fresnel lens having an imaging function, and further refracted by the convex lens 621 or Fresnel lens having an imaging function to generate the real image 601. Thereafter, the position of the real image 601 is altered by means of the scanning of the scanning mirror 631, thereby generating a floating virtual image 60. The floating virtual image 60 is allowed to display a variable virtual image like a floating moving screen by controlling the light source 61 to emit different bright, dark light beams corresponding to an image through the image signal processing unit 64.

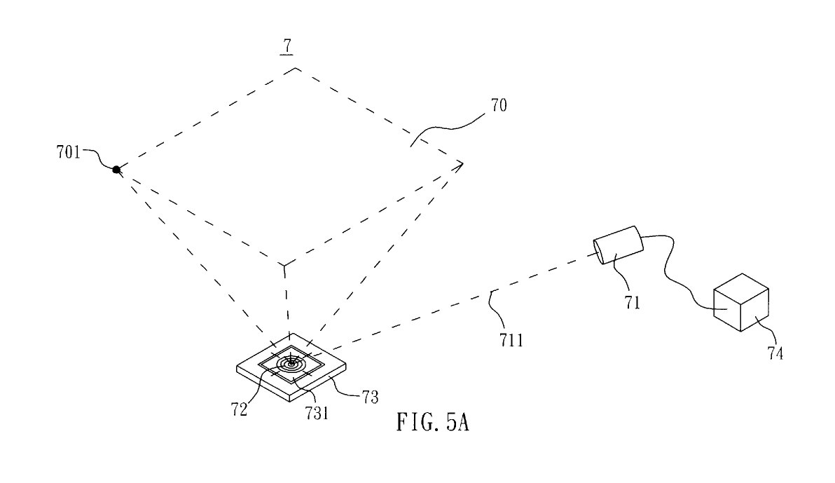

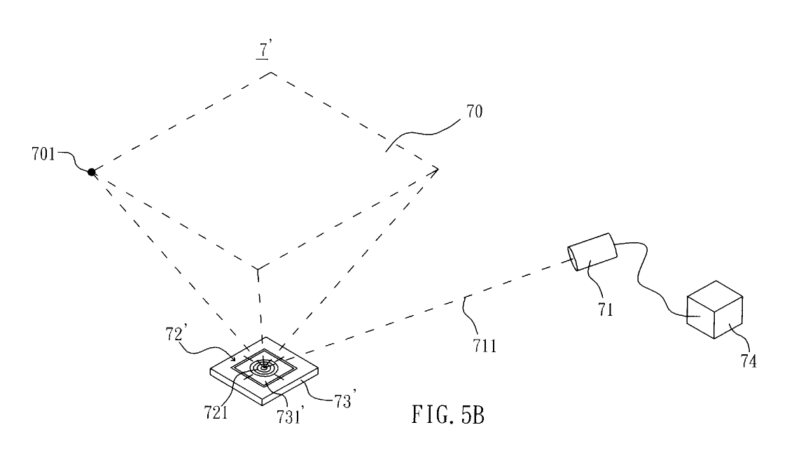

Referring to FIG. 5A, a floating virtual real image display apparatus 7 of a fourth embodiment of the present invention includes a high-power light source 71, a real image imaging unit 72, a scanning mechanism 73 and an image signal processing unit 74. The light source 71 is electrically connected to the image signal processing unit 74, and the scanning mechanism 73 is installed with a scanning unit 731. The real image imaging unit 72 of the present embodiment is a concave lens coupled to the scanning unit 731, and can carry out a scanning with the scanning unit 731 in a way similar to the scanning of the scanning mirror in the third embodiment.

A light beam 711 is reflected and refracted by the real image imaging unit (concave lens) 72 to generate a real image 701 when the light beam 711 is emitted from the light source 71. A floating virtual image 70 is displayed to a human's vision through human persistence of vision after the position of the real image 701 is altered through the scanning of the real image imaging unit (concave lens) 72 driven by the scanning unit 731 with a scanning speed of more than 24 times per second to the whole picture of the virtual image 70. The floating virtual image 70 is allowed to display a variable virtual image like a floating moving screen by controlling the light source 71 to emit different bright, dark light beams corresponding to an image through the image signal processing unit 74.

Referring to FIG. 5B, a floating virtual real image display apparatus 7′ of a fifth embodiment of the present invention includes a high-power light source 71, a real image imaging unit 72′, a scanning mechanism 73′ and an image signal processing unit 74. The light source 71 is electrically connected to the image signal processing unit 74, and the scanning mechanism 73′ is installed with a scanning mirror 731′.

The real image imaging unit 72′ of the present embodiment includes a combination of a convex lens 721 or a Fresnel lens and the scanning mirror 731′. The convex lens 721 or Fresnel lens having an imaging function is combined with the scanning mirror 731′ and can carry out a scanning with the scanning mirror 731′ in a way similar to the scanning of the scanning mirror in the third embodiment.

A light beam 711 is reflected and refracted by the real image imaging unit 72′ to generate a real image 701 when the light beam 711 is emitted from the light source 71. A floating virtual image 70 is displayed to a human's vision through human persistence of vision after the position of the real image 701 is altered through the scanning of the scanning mechanism 73′ with a scanning speed of more than 24 times per second to the whole picture of the virtual image 70. The floating virtual image 70 is allowed to display a variable virtual image like a floating moving screen by controlling the light source 71 to emit different bright, dark light beams corresponding to an image through the image signal processing unit 74.

When the light beam 711 emitted from the light source 71 of the present embodiment, the light beam 711 is reflected by the scanning mirror 731′ and then refracted by the convex lens 721 or Fresnel lens having an imaging function to generate a real image 701; a floating virtual image 70 is generated by driving the convex lens 721 or the Fresnel lens having an imaging function to scan through the scanning mirror 731′.

The scanning mechanism in the third to fifth embodiments of the present invention may be a conventional micro electro mechanical system (MEMS) scanning mechanism, and the light source in each embodiment mentioned above may be a light-emitting diode (LED) or laser light source.

In the floating virtual real image display apparatus of the present invention, a light beam is reflected and refracted by the real image imaging unit to generate a real image corresponding to the light source when the light beam is emitted from the light source; a floating virtual image like a floating virtual screen is generated after the position of the real image is altered through the scanning of the scanning mechanism; the floating virtual image is allowed to display a variable virtual image like a floating moving screen by controlling the light source to emit bright, dark lines corresponding to an image such that a traditional screen can be omitted thereby reducing the cost.

Additional advantages and modifications will readily occur to those skilled in the art. Therefore, the invention in its broader aspects is not limited to the specific details and representative embodiments shown and described herein. Accordingly, various modifications may be made without. departing from the spirit or scope of the general inventive concept as defined by the appended claims and their equivalents.

What is claimed is:

1. A floating virtual real image display apparatus, comprising:
a real image imaging unit;
a ht source; and
a scanning mechanism;
wherein, a light beam is reflected and refracted by said real image imaging unit to generate a real image corresponding to said light source when said light beam is emitted from said light source; a position of said real image is altered through a scanning of said scanning mechanism to generate a floating virtual image.

2. The floating virtual real image display apparatus according to claim 1, wherein said scanning mechanism is configured with a first motor, a first shaft, a first bracket, a second motor, a second shaft and a second bracket; said first bracket is respectively coupled to said first shaft and said second motor, and said second shaft is coupled to said second bracket; when said first motor drives said first shaft to rotate, said first bracket is allowed to take said first shaft as a rotating axis scanning from left to right repeatedly; when said second motor drives said second shaft to rotate, said second bracket is allowed to take said second shaft as a rotating axis scanning up-down repeatedly; said light source, said real image imaging unit and said image signal processing unit are respectively coupled to said second bracket.

3. The floating virtual real image display apparatus according to claim 2, wherein said real image imaging unit is a concave lens; said light beam is reflected and refracted by said concave lens to generate said real image.

4. The floating virtual real image display apparatus according to claim 2, wherein said real image imaging unit comprises a mirror and one selected from a convex lens and Fresnel lens having an imaging function; said light beam is reflected by said mirror to said convex lens or said Fresnel lens having an imaging function, and then refracted by said convex lens or said Fresnel lens having an imaging function to generate said real image.

5. The floating virtual real image display apparatus according to claim 1, wherein said scanning mechanism is configured with a scanning mirror; said real image imaging unit comprises said scanning mirror and one selected from a convex lens and Fresnel lens having an imaging function; a light beam emitted from said light source is reflected by said scanning mirror to said convex lens or said Fresnel lens having an imaging function, and then refracted by said convex lens or said Fresnel lens having an imaging function to generate said real image, meanwhile, scanned by said scanning mirror to generate said floating virtual image.

6. The floating virtual real image display apparatus according to claim 5, wherein said scanning mechanism is a micro electro mechanical system scanning mechanism.

7. The floating virtual real image display apparatus according to claim 1, wherein said scanning mechanism is configured with a scanning unit; said real image imaging unit is a concave lens; said concave lens is coupled to said scanning unit and carries out a scanning with said scanning unit; a light beam is reflected and refracted by said concave lens to generate said real image when said light beam is emitted from said light source; said floating virtual image is generated through a scanning of said concave lens driven by said scanning unit.

8. The floating virtual real image display apparatus according to claim 7, wherein said scanning mechanism is a micro electro mechanical system scanning mechanism.

9. The floating virtual real image display apparatus according to claim 1, wherein said scanning mechanism is configured with a scanning mirror; said real image imaging unit comprises a combination of said scanning mirror and one selected from a convex lens and Fresnel lens having an imaging function; said convex lens or said Fresnel lens having an imaging function is coupled to said scanning mirror and carries a scanning with said scanning mirror; a light beam emitted from said light source is reflected by said scanning mirror to said convex lens or said Fresnel lens having an imaging function, and then refracted by said convex lens or said Fresnel lens having an imaging function to generate said real image; said floating virtual image is generated through a scanning of said convex lens or said Fresnel lens having an imaging function driven by said scanning mirror.

10. The floating virtual real image display apparatus according to claim 9, wherein said scanning mechanism is a micro electro mechanical system scanning mechanism.

11. The floating virtual real image display apparatus according to any one of claim 1, further comprising an image signal processing unit; said light source being electrically coupled to said image signal processing unit; said floating virtual image being allowed to display a variable virtual image by controlling said light source to emit bright, dark light beams corresponding to an image through said image signal processing unit.

12. The floating virtual real image display apparatus according to claim 11, wherein said light source is one selected from a light-emitting diode and laser light source.

13. The floating virtual real image display apparatus according to any one of claim 3, further comprising an image signal processing unit; said light source being electrically coupled to said image signal processing unit; said floating virtual image being allowed to display a variable virtual image by controlling said light source to emit bright, dark light beams corresponding to an image through said image signal processing unit; said light source is one selected from a light-emitting diode and laser light source.

14. The floating virtual real image display apparatus according to any one of claim 4, further comprising an image signal processing unit; said light source being electrically coupled to said image signal processing unit; said floating virtual image being allowed to display a variable virtual image by controlling said light source to emit bright, dark light beams corresponding to an image through said image signal processing unit; said light source is one selected from a light-emitting diode

15. The floating virtual real image display apparatus according to any one of claim 6, further comprising an image signal processing unit; said light source being electrically coupled to said image signal processing unit; said floating virtual image being allowed to display a variable virtual image by controlling said light source to emit bright, dark light beams corresponding to an image through said image signal processing unit.

16. The floating virtual real image display apparatus according to any one of claim 8, further comprising an image signal processing unit; said light source being electrically coupled to said image signal processing unit; said floating virtual image being allowed to display a variable virtual image by controlling said light source to emit bright, dark light beams corresponding to an image through said image signal processing unit.

17. The floating virtual real image display apparatus according to any one of claim 10, further comprising an image signal processing unit; said light source being electrically coupled to said image signal processing unit; said floating virtual image being allowed to display a variable virtual image by controlling said light source to emit bright, dark light beams corresponding to an image through said image signal processing unit.

18. The floating virtual real image display apparatus according to claim 15, wherein said light source is one selected from a light-emitting diode and laser light source.

19. The floating virtual real image display apparatus according to claim 16, wherein said light source is one selected from a light-emitting diode and laser light source.

20. The floating virtual real image display apparatus according to claim 17, wherein said light source is one selected from a light-emitting diode and laser light source.
